(19) United States
(12) Patent Application Publication
(10) Pub. No.: US 2017/0094154 A1
(43) Pub. Date: Mar. 30, 2017

(54) CORRECTION SYSTEM OF IMAGE PICKUP APPARATUS, WORK MACHINE, AND CORRECTION METHOD OF IMAGE PICKUP APPARATUS

(71) Applicant: KOMATSU LTD., Minato-ku, Tokyo (JP)

(72) Inventors: Shun Kawamoto, Hiratsuka-shi (JP); Taiki Sugawara, Hiratsuka-shi (JP); Hiroyoshi Yamaguchi, Hiratsuka-shi (JP)

(21) Appl. No.: 14/908,392

(22) PCT Filed: Sep. 30, 2015
(86) PCT No.: PCT/JP2015/077873

§ 371 Date: Jan. 28, 2016

(51) Int. Cl. H04N 5/232; G01C 11/06; H04N 5/225; G01C 3/08; E02F 9/26; H04N 5/247

(52) U.S. Cl. CPC H04N 5/23216; E02F 9/261; H04N 5/247; H04N 5/2251; G01C 3/08; G01C 11/06; E02F 3/32

(57) ABSTRACT

A correction system of an image pickup apparatus includes at least two image pickup apparatuses and a processing apparatus that changes a parameter defining a posture of the second image pickup apparatus by setting a distance between a first image pickup apparatus and a second image pickup apparatus constant in the at least two image pickup apparatuses, searches a corresponding portion between a pair of images obtained by the first image pickup apparatus and the second image pickup apparatus, and obtains the parameter based on the searched result.

### FIELD

The present invention relates to a correction system of an image pickup apparatus, a work machine, and a correction method of the image pickup apparatus in order to correct the image pickup apparatus provided in the work machine.

### BACKGROUND

There is a work machine which includes an image pickup apparatus (for example, Patent Literature 1). Such a work machine picks up an image of an object by the image pickup apparatus, controls its own operation based on the pickup image result, and sends information of the pickup image to a management apparatus.

### CITATION LIST

### Patent Literature

Patent Literature 1: Japanese Laid-open Patent Publication No. 2012-233353

### SUMMARY

### Technical Problem

Patent Literature 1 discloses a technology of correcting a work machine using the image pickup apparatus. However, the correction of the image pickup apparatus of the work machine is neither disclosed nor suggested in Patent Literature 1.

An object of the invention is to correct an image pickup apparatus of a work machine.

### Solution to Problem

According to the present invention, a correction system of an image pickup apparatus comprises: at least two image pickup apparatuses; and a processing apparatus that sets a distance between a first image pickup apparatus and a second image pickup apparatus constant in the at least two image pickup apparatuses, changes a parameter defining a posture of the second image pickup apparatus, searches a corresponding portion between a pair of images obtained by the first image pickup apparatus and the second image pickup apparatus, and obtains the parameter based on the searched result.

It is preferable that the processing apparatus includes a search unit which sets a distance between a first image pickup apparatus and a second image pickup apparatus constant in the at least two image pickup apparatuses and changes a parameter defining a posture of the second image pickup apparatus so as to search a corresponding portion between a pair of images obtained by the first image pickup apparatus and the second image pickup apparatus, and a determination unit which obtains a posture parameter defining a posture of the image pickup apparatus based on a result searched by the search unit.

It is preferable that wherein the parameter defines a rotation of the second image pickup apparatus.

It is preferable that wherein the parameter includes a first parameter that is used to rotate the second image pickup apparatus with the first image pickup apparatus as a center, and a second parameter that is used to rotate the second image pickup apparatus about a center of the second image pickup apparatus.

It is preferable that wherein the processing apparatus determines the first image pickup apparatus and the second image pickup apparatus, of which the parameter is necessarily obtained, based on the result of searching the corresponding portion between the pair of images obtained by a pair of the image pickup apparatuses in the at least two image pickup apparatuses.

It is preferable that wherein the processing apparatus obtains the parameter with respect to a pair of the image pickup apparatuses of which a success rate of a searching is less than a threshold in a case where there are a plurality of the pairs of image pickup apparatuses.

According to the present invention, a work machine comprises: the correction system of the image pickup apparatus; and a plurality of image pickup apparatuses.

According to the present invention, a correction method of an image pickup apparatus, comprises: determining whether a parameter of one of a pair of image pickup apparatuses needs to be obtained based on a result of searching a corresponding portion between a pair of images obtained by the pair of image pickup apparatuses in a plurality of image pickup apparatuses; in a case the parameter is obtained, setting a distance between a first image pickup apparatus and a second image pickup apparatus of the pair of image pickup apparatuses constant, and changing a parameter defining a posture of the second image pickup apparatus so as to search a corresponding portion between a pair of images obtained by the first image pickup apparatus and the second image pickup apparatus; and obtaining a posture parameter defining a posture of the image pickup apparatus based on a searching result.

According to the invention, it is possible to suppress that work efficiency is reduced when a work is performed using a work machine provided with a work machine equipped with an operation tool.

### BRIEF DESCRIPTION OF DRAWINGS

FIG. 1 is a perspective view an excavator which is provided with a correction system of an image pickup apparatus according to an embodiment.

FIG. 2 is a perspective view illustrating the surroundings of a driver seat of the excavator according to the embodiment.

FIG. 3 is a diagram illustrating dimensions and a coordinate system of a work machine of the excavator according to the embodiment.

FIG. 4 is a diagram illustrating an example of an image obtained by picking up an object using a plurality of image pickup apparatuses.

FIG. 5 is a diagram illustrating an example of an object picked up by the plurality of image pickup apparatuses.

FIG. 6 is a diagram illustrating the correction system of the image pickup apparatus according to the embodiment.

FIG. 7 is a diagram for describing an example of measuring a blade edge of a blade of a bucket in a three-dimensional manner using a pair of image pickup apparatuses.

FIG. 8 is a diagram illustrating a pair of images obtained by a pair of image pickup apparatuses.

FIG. 9 is a diagram illustrating a pair of images obtained by the pair of image pickup apparatuses.

FIG. 10 is a perspective view illustrating a positional relation between the pair of image pickup apparatuses.

FIG. 11 is a diagram for describing a deviation of the image pickup apparatus with respect to the image pickup apparatus.

FIG. 12 is a diagram illustrating a pair of images obtained by the pair of image pickup apparatuses.

FIG. 13 is a diagram illustrating a pair of images obtained by the pair of image pickup apparatuses.

FIG. 14 is a flowchart illustrating a process when the correction system according to the embodiment performs a correction method according to the embodiment.

FIG. 15 is a diagram for describing a method of determining the image pickup apparatus to obtain a posture parameter.

FIG. 16 is a diagram illustrating an example of a table for determining the image pickup apparatus to obtain the posture parameter.

FIG. 17 is a diagram for describing the posture parameter.

FIG. 18 is a diagram for describing the posture parameter.

FIG. 19 is a diagram for describing the posture parameter.

FIG. 20 is a diagram for describing the posture parameter.

FIG. 21 is a diagram for describing the posture parameter.

### DESCRIPTION OF EMBODIMENTS

Embodiments of the invention will be described in detail with reference with the drawings.

<Entire Configuration of Excavator>

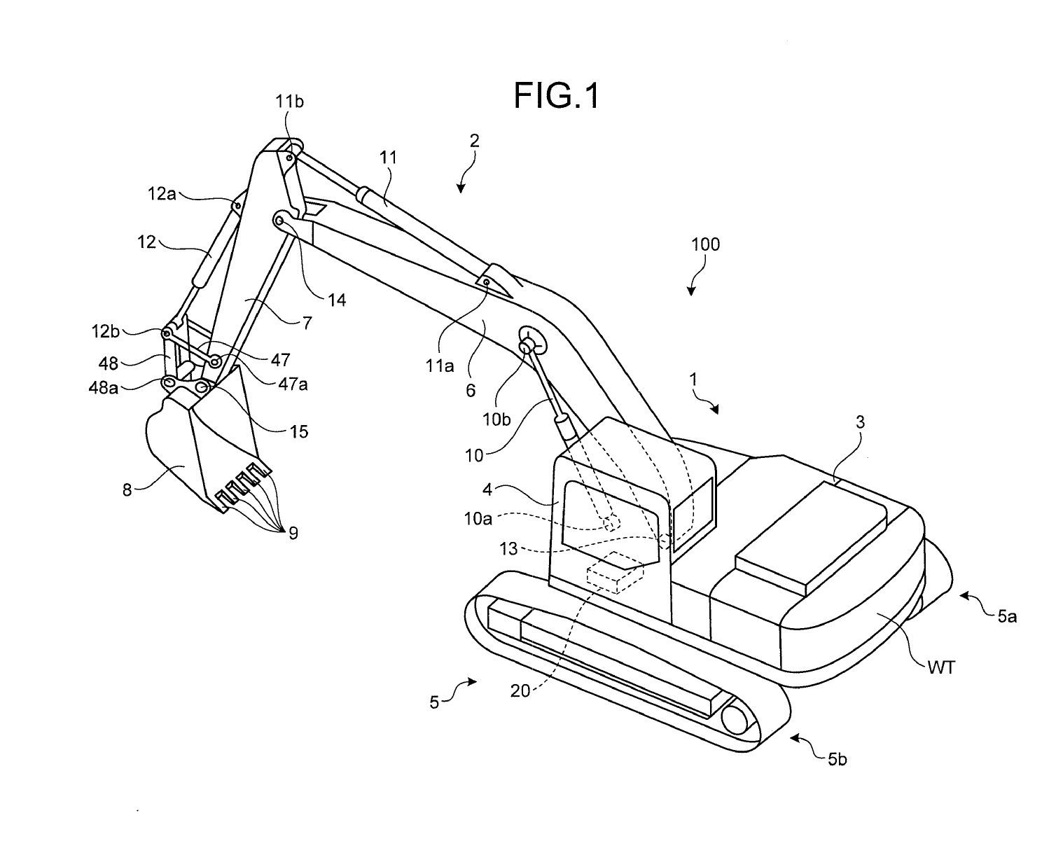

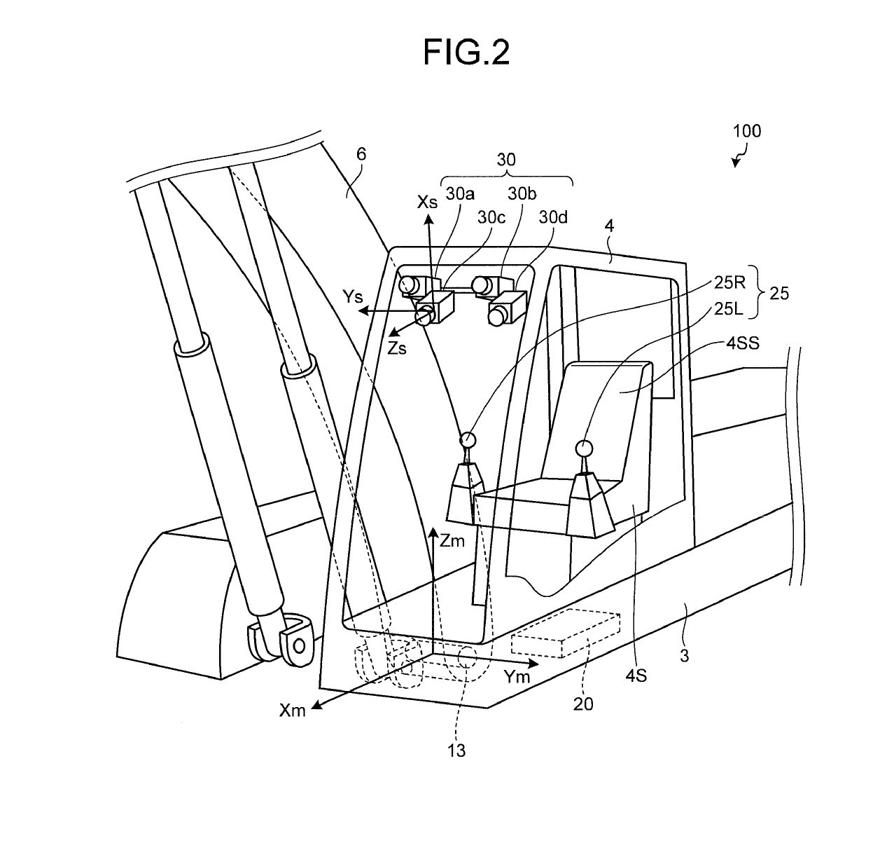

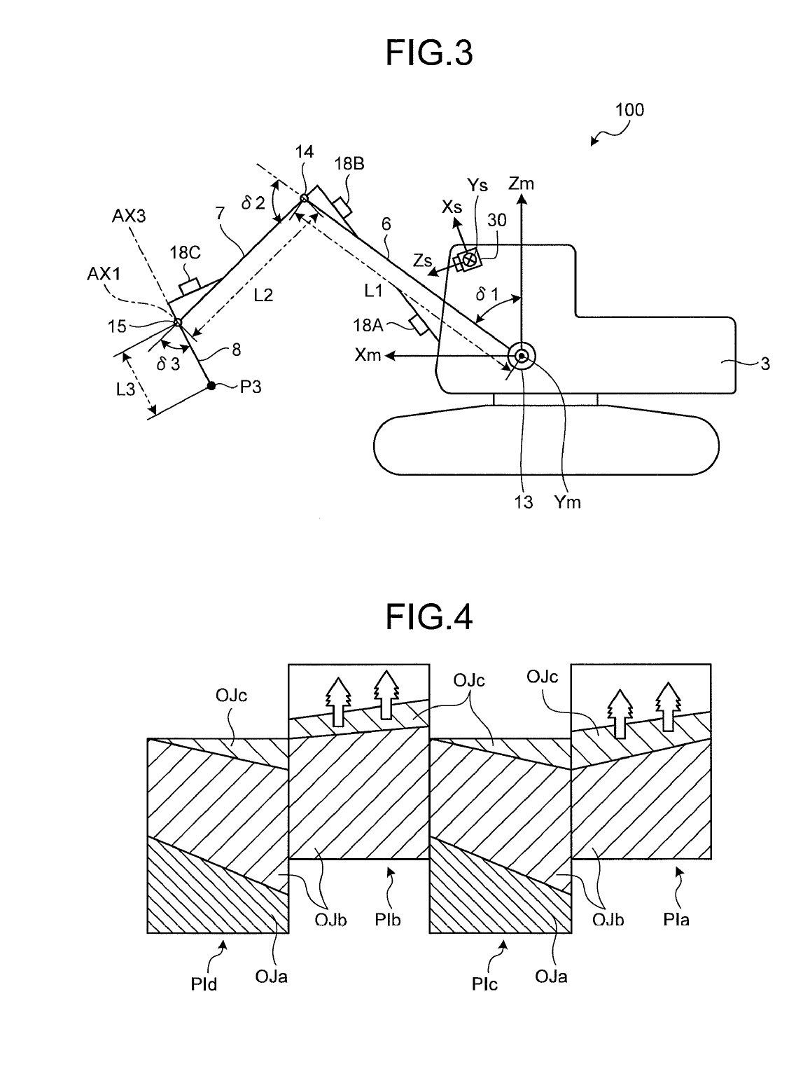

FIG. 1 is a perspective view of an excavator 100 which is provided with a correction system of an image pickup apparatus according to an embodiment. FIG. 2 is a perspective view illustrating the surroundings of a driver seat of the excavator 100 according to the embodiment. FIG. 3 is a diagram illustrating dimensions of a work machine 2 of the excavator according to the embodiment and a coordinate system of the excavator 100.

The excavator 100 as a work machine includes a vehicle body 1 and the work machine 2. The vehicle body 1 includes a revolving superstructure 3, a cab 4, and a traveling body 5. The revolving superstructure 3 is attached to the traveling body 5 to be freely revolved. The revolving superstructure 3 contains apparatuses (not illustrated) such as a hydraulic pump and an engine. The cab 4 is disposed in the front portion of the revolving superstructure 3. In the cab 4, an operation apparatus 25 illustrated in FIG. 2 is disposed. The traveling body 5 includes crawler belts 5a and 5b, and the excavator 100 travels by the rotation of the crawler belts 5a and 5b.

The work machine 2 is attached to the front portion of the vehicle body 1, and includes a boom 6, an arm 7, a bucket 8 as an operation tool, a boom cylinder 10, an arm cylinder 11, and a bucket cylinder 12. In the embodiment, the forward side of the vehicle body 1 is a direction from a backrest 4SS of a driver seat 4S illustrated in FIG. 2 toward the operation apparatus 25. The backward side of the vehicle body 1 is a direction from the operation apparatus 25 toward the backrest 4SS of the driver seat 4S. The front portion of the vehicle body 1 is a portion on the forward side of the vehicle body 1, and a portion opposite to a counter weight WT of the vehicle body 1. The operation apparatus 25 is an apparatus for operating the work machine 2 and the revolving superstructure 3, and includes a right lever 25R and a left lever 25L.

The base end portion of the boom 6 is rotatably attached to the front portion of the vehicle body 1 through a boom pin 13. The boom pin 13 corresponds to the rotation center with respect to the revolving superstructure 3 of the boom 6. The base end portion of the arm 7 is rotatably attached to the end portion of the boom 6 through an arm pin 14. The arm pin 14 corresponds to the rotation center with respect to the boom 6 of the arm 7. The bucket 8 is rotatably attached to the end portion of the arm 7 through a bucket pin 15. The bucket pin 15 corresponds to the rotation center with respect to the arm 7 of the bucket 8.

As illustrated in FIG. 3, the length of the boom 6 (that is, a length between the boom pin 13 and the arm pin 14) is L1. The length of the arm 7 (that is, a length between the arm pin 14 and the bucket pin 15) is L2. The length of the bucket 8 (that is, a length between the bucket pin 15 and a blade edge P3 which is the end of a blade 9 of the bucket 8) is L3.

The boom cylinder 10, the arm cylinder 11, and the bucket cylinder 12 illustrated in FIG. 1 each are hydraulic cylinders driven by oil pressure. The base end portion of the boom cylinder 10 is rotatably attached to the revolving superstructure 3 through a boom cylinder foot pin 10a. The end portion of the boom cylinder 10 is rotatably attached to the boom 6 through a boom cylinder top pin 10b. The boom cylinder 10 is extended or compressed by the oil pressure so as to drive the boom 6.

The base end portion of the arm cylinder 11 is rotatably attached to the boom 6 through an arm cylinder foot pin 11a. The end portion of the arm cylinder 11 is rotatably attached to the arm 7 through an arm cylinder top pin 11b. The arm cylinder 11 is extended or compressed by the oil pressure so as to drive the arm 7.

The base end portion of the bucket cylinder 12 is rotatably attached to the arm 7 through a bucket cylinder foot pin 12a. The end portion of the bucket cylinder 12 is rotatably attached to one end of a first link member 47 and one end of a second link member 48 through a bucket cylinder top pin 12b. The other end of the first link member 47 is rotatably attached to the end portion of the arm 7 through a first link pin 47a. The other end of the second link member 48 is rotatably attached to the bucket 8 through a second link pin 48a. The bucket cylinder 12 is extended or compressed by the oil pressure so as to drive the bucket 8.

As illustrated in FIG. 3, a first angle detection unit 18A, a second angle detection unit 18B, and a third angle detection unit 18C are provided in the boom 6, the arm 7, and the bucket 8, respectively. The first angle detection unit 18A, the second angle detection unit 18B, and the third angle detection unit 18C are stroke sensors for example. These units indirectly detect a rotational angle of the boom 6 with respect to the vehicle body 1, a rotational angle of the arm 7 with respect to the boom 6, and a rotational angle of the bucket 8 with respect to the arm 7 by detecting the stroke lengths of the boom cylinder 10, the arm cylinder 11, and the bucket cylinder 12.

In the embodiment, the first angle detection unit 18A detects the stroke length of the boom cylinder 10. A processing apparatus 20 described below calculates a rotational angle δ1 of the boom 6 with respect to the Zm axis in a coordinate system (Xm, Ym, Zm) of the excavator 100 illustrated in FIG. 3 based on the stroke length of the boom cylinder 10 detected by the first angle detection unit 18A. In the following description, the coordinate system of the excavator 100 will be appropriately referred to as a vehicle body coordinate system. As illustrated in FIG. 2, for example, the original point of the vehicle body coordinate system is the center of the boom pin 13. The center of the boom pin 13 means the center in a flat surface orthogonal to an extending direction of the boom pin 13 when being viewed in cross section of the boom pin 13, and the center in the extending direction of the boom pin 13. The vehicle body coordinate system is not limited to the example of the embodiment. For example, a revolving center of the revolving superstructure 3 may be set to the Zm axis, an axial line parallel to the extending direction of the boom pin 13 may be set to the Ym axis, and an axial line orthogonal to the Zm and Ym axes may be set to the Xm axis.

The second angle detection unit 18B detects a stroke length of the arm cylinder 11. The processing apparatus 20 calculates a rotational angle δ2 of the arm 7 with respect to the boom 6 based on the stroke length of the arm cylinder 11 detected by the second angle detection unit 18B. The third angle detection unit 18C detects a stroke length of the bucket cylinder 12. The processing apparatus 20 calculates a rotational angle δ3 of the bucket 8 with respect to the arm 7 based on the stroke length of the bucket cylinder 12 detected by the third angle detection unit 18C.

<Image Pickup Apparatus>

As illustrated in FIG. 2, the excavator 100 includes, for example, a plurality of image pickup apparatuses 30a, 30b, 30c, and 30d in the cab 4. In the following description, the plurality of image pickup apparatuses 30a, 30b, 30c, and 30d will be appropriately referred to as an image pickup apparatus 30 in a case where there is no need to distinguish these apparatuses. The image pickup apparatus 30a and the image pickup apparatus 30c are disposed on a side near the work machine 2. The type of the image pickup apparatus 30 is not limited and, for example, an image pickup apparatus provided with a CCD (Couple Charged Device) image sensor or a CMOS (Complementary Metal Oxide Semiconductor) image sensor is employed in the embodiment.

As illustrated in FIG. 2, the image pickup apparatus 30a and the image pickup apparatus 30b are disposed in the cab 4 toward a direction equal to or different from each other with a predetermined gap therebetween. The image pickup apparatus 30c and the image pickup apparatus 30d are disposed, for example, in the cab 4 toward a direction equal to or different from each other with a predetermined gap therebetween. The plurality of image pickup apparatuses 30a, 30b, 30c, and 30d are combined by two so as to form a stereo camera. In the embodiment, the stereo camera is configured by a combination of the image pickup apparatuses 30a and 30b and a combination of the image pickup apparatuses 30c and 30d. In the embodiment, the image pickup apparatus 30a and the image pickup apparatus 30b are disposed upward, and the image pickup apparatus 30c and the image pickup apparatus 30d are disposed downward. At least the image pickup apparatus 30a and the image pickup apparatus 30c are disposed to face the forward side of the excavator 100 (the revolving superstructure 3 in the embodiment). The image pickup apparatus 30b and the image pickup apparatus 30d may be disposed slightly toward the work machine 2 (that is, slightly toward the image pickup apparatus 30a and the image pickup apparatus 30c).

In the embodiment, the excavator 100 includes four image pickup apparatuses 30, but the number of image pickup apparatuses 30 of the excavator 100 is not limited to four and may be at least two. The excavator 100 is configured with is not limited to four using at least a pair of image pickup apparatuses 30 to pick up the stereo image of an object.

The plurality of image pickup apparatuses 30a, 30b, 30c, and 30d are disposed on the forward side and the upward side of the cab 4. The upward side is a direction orthogonal to the grounding surface of the crawler belts 5a and 5b of the excavator 100 and separated from the grounding surface. The grounding surface of the crawler belts 5a and 5b is a flat surface defined by at least three points not on the same straight line in a portion where at least one of the crawler belts 5a and 5b is grounded. The plurality of image pickup apparatuses 30a, 30b, 30c, and 30d stereoscopically picks up the image of the object on the forward side of the vehicle body 1 of the excavator 100. The object is, for example, an object to be dug by the work machine 2. The processing apparatus 20 illustrated in FIGS. 1 and 2 measures the object in a three-dimensional manner using a resultant image stereoscopically picked-up by at least a pair of image pickup apparatuses 30. In a case where the plurality of image pickup apparatuses 30a, 30b, 30c, and 30d are disposed, the locations are not limited to the forward side and the upward side in the cab 4.

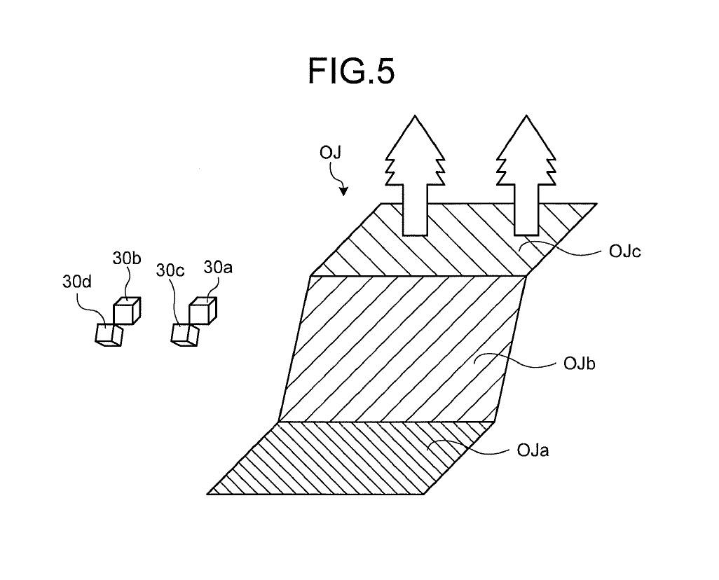

FIG. 4 is a diagram illustrating an example of an image obtained by picking up an object using the plurality of image pickup apparatuses 30a, 30b, 30c, and 30d. FIG. 5 is a diagram illustrating an example of an object OJ picked up by the plurality of image pickup apparatuses 30a, 30b, 30c, and 30d. For example, images PIa, PIb, PIc, and PId illustrated in FIG. 4 are obtained by picking up the object OJ using the plurality of image pickup apparatuses 30a, 30b, 30c, and 30d illustrated in FIG. 5. In this example, the object OJ includes a first portion OJa, a second portion OJb, and a third portion OJc.

The image PIa is an image picked up by the image pickup apparatus 30a, the image PIb is an image picked up by the image pickup apparatus 30b, the image PIc is an image picked up by the image pickup apparatus 30c, the image PId is an image picked up by the image pickup apparatus 30d. Since the pair of image pickup apparatuses 30a and 30b are disposed to face the upward of the excavator 100, the upper portion of the object OJ is taken in the images PIa and PIb. Since the pair of image pickup apparatuses 30c and 30d are disposed to face the downward of the excavator 100, the lower portion of the object OJ is taken in the images PIc and PId.

As can be seen from FIG. 4, a part of the entire object OJ (the second portion OJb in this example) is overlapped in the images PIa and PIb picked up by the pair of image pickup apparatuses 30a and 30b, and the images PIc and PId picked up by the pair of image pickup apparatuses 30c and 30d. In other words, there is an overlapped portion in the pickup region of the pair of image pickup apparatuses 30a and 30b facing the upward and the pickup region of the pair of image pickup apparatuses 30c and 30d facing the downward.

The processing apparatus 20 obtains a first parallax image from the images PIa and PIb picked up by the pair of image pickup apparatuses 30a and 30b in a case where stereoscopic image processing is performed on the images PIa, PIb, PIc, and PId of the same object OJ picked up by the plurality of image pickup apparatuses 30a, 30b, 30c, and 30d. In addition, the processing apparatus 20 obtains a second parallax image from the images PIc and PId picked up by the pair of image pickup apparatuses 30c and 30d. Thereafter, the processing apparatus 20 obtains one parallax image by combining the first parallax image and the second parallax image. The processing apparatus 20 measures the object in the three-dimensional manner using the obtained parallax images. In this way, the processing apparatus 20 and the plurality of image pickup apparatuses 30a, 30b, 30c, and 30d measure the entire of a predetermined region of the object OJ picked up at one time in the three-dimensional manner.

In the embodiment, for example, the image pickup apparatus 30c is used as a reference among four image pickup apparatuses 30a, 30b, 30c, and 30d. Four image pickup apparatuses 30a, 30b, 30c, and 30d each include the coordinate system. These coordinate systems will be appropriately referred to as an image pickup apparatus coordinate system. In FIG. 2, only the coordinate system (Xs, Ys, Zs) of the image pickup apparatus 30c serving as the reference is illustrated. The original point of the image pickup apparatus coordinate system is the center of each of the image pickup apparatuses 30a, 30b, 30c, and 30d.

<Correction System of Image Pickup Apparatus>

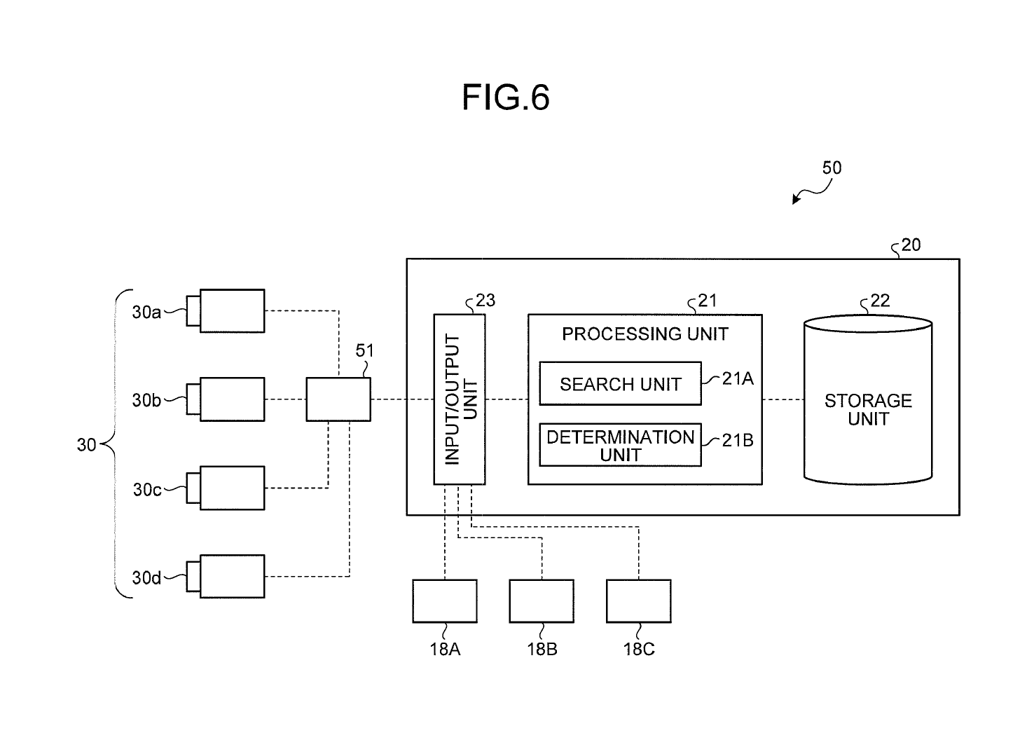

FIG. 6 is a diagram illustrating a correction system 50 of the image pickup apparatus according to the embodiment. The correction system 50 of the image pickup apparatus (hereinafter, appropriately referred to as the correction system 50) includes the plurality of image pickup apparatuses 30a, 30b, 30c, and 30d and the processing apparatus 20. As illustrated in FIGS. 1 and 2, these apparatuses are provided in the vehicle body 1 of the excavator 100. The processing apparatus 20 includes a processing unit 21, a storage unit 22, and an input/output unit 23. The processing unit 21 is, for example, realized by a processor such as a CPU (Central Processing Unit) and a memory. The processing unit 21 includes a search unit 21A and a determination unit 21B. The processing apparatus 20 realizes a correction method of the image pickup apparatus according to the embodiment (hereinafter, appropriately referred to as a correction method). In this case, the processing unit 21 reads and executes a computer program stored in the storage unit 22. The computer program is used for performing the correction method according to the embodiment in the processing unit 21.

In a case where the image pickup apparatus 30 is moved by some reasons, the correction method according to the embodiment corrects a positional deviation of the image pickup apparatus 30 to realize the three-dimensional measurement using the resultant image stereoscopically picked up by at least one pair of image pickup apparatuses 30. It will be assumed that the positional deviation occurs between the image pickup apparatus 30c and the image pickup apparatus 30d among four image pickup apparatuses 30a, 30b, 30c, and 30d. In this case, the processing unit 21 of the processing apparatus 20 performs the correction method according to the embodiment. The image pickup apparatus 30c and the image pickup apparatus 30d subjected to the correction method according to the embodiment will be respectively referred to as a first image pickup apparatus 30c and a second image pickup apparatus 30d.

The processing unit 21 sets a constant distance between the first image pickup apparatus 30c and the second image pickup apparatus 30d among four (at least two) image pickup apparatuses 30a, 30b, 30c, and 30d in the embodiment when the correction method according to the embodiment is performed, and changes a parameter defining a posture of the second image pickup apparatus 30d. Then, the processing unit 21 obtains the parameter based on a result of searching the corresponding portions between a pair of images obtained by the first image pickup apparatus 30c and the second image pickup apparatus 30d during the image processing (the stereoscopic image processing in the embodiment). The search unit 21A of the processing unit 21 changes and searches the parameter. The determination unit 21A of the processing unit 21 obtains the parameter based on the searching result. The stereoscopic image processing is a method of obtaining a distance to the object based on two images obtained by observing the same object from different two image pickup apparatuses 30. The distance to the object is, for example, expressed by visualizing distance information to the object as a distance image in gradation.

When the correction method according to the embodiment is performed, the processing apparatus 20 performs the stereoscopic image processing on the pair of images picked up by the pair of image pickup apparatuses 30 to obtain the position of the object (specifically, the coordinates of the object in the three-dimensional coordinate system). In this way, the processing apparatus 20 can measure the object in the three-dimensional manner using the pair of images obtained by picking up the same object using at least the pair of image pickup apparatuses 30. In other words, at least the pair of image pickup apparatuses 30 and the processing apparatus 20 measure the object in the three-dimensional manner by the stereoscopic method.

The storage unit 22 is configured by at least one of a non-volatile or volatile semiconductor memory such as a RAM (Random Access Memory), a ROM (Random Access Memory), a flash memory, an EPROM (Erasable Programmable Random Access Memory), or an EEPROM (Electrically Erasable Programmable Random Access Memory), a magnetic disk, a flexible disk, and a magneto-optical disk. The storage unit 22 stores the computer program therein for performing the correction method according to the embodiment in the processing unit 21. The storage unit 22 stores information therein to be used when the processing unit 21 performs the correction method according to the embodiment. The information includes, for example, information necessary for obtaining the position of a part of the work machine 2 based on internal correction data of the image pickup apparatus 30, the posture of each image pickup apparatus 30, and a positional relation between the image pickup apparatuses 30, and the posture of the work machine 2.

The input/output unit 23 is an interface circuit for the connection between the processing apparatus 20 and machines. A bus 51, the first angle detection unit 18A, the second angle detection unit 18B, and the third angle detection unit 18C are connected to the input/output unit 23. The bus 51 is connected to the plurality of image pickup apparatuses 30a, 30b, 30c, and 30d. The resultant images picked up by the image pickup apparatuses 30a, 30b, 30c, and 30d are input to the input/output unit 23 through the bus 51. The processing unit 21 acquires the resultant images picked up by the image pickup apparatuses 30a, 30b, 30c, and 30d through the bus 51 and the input/output unit 23. The processing apparatus 20 may be realized by a dedicated software product, or may be realized by a function of the processing apparatus 20 in cooperation of a plurality of circuits.

<Three-Dimensional Measurement>

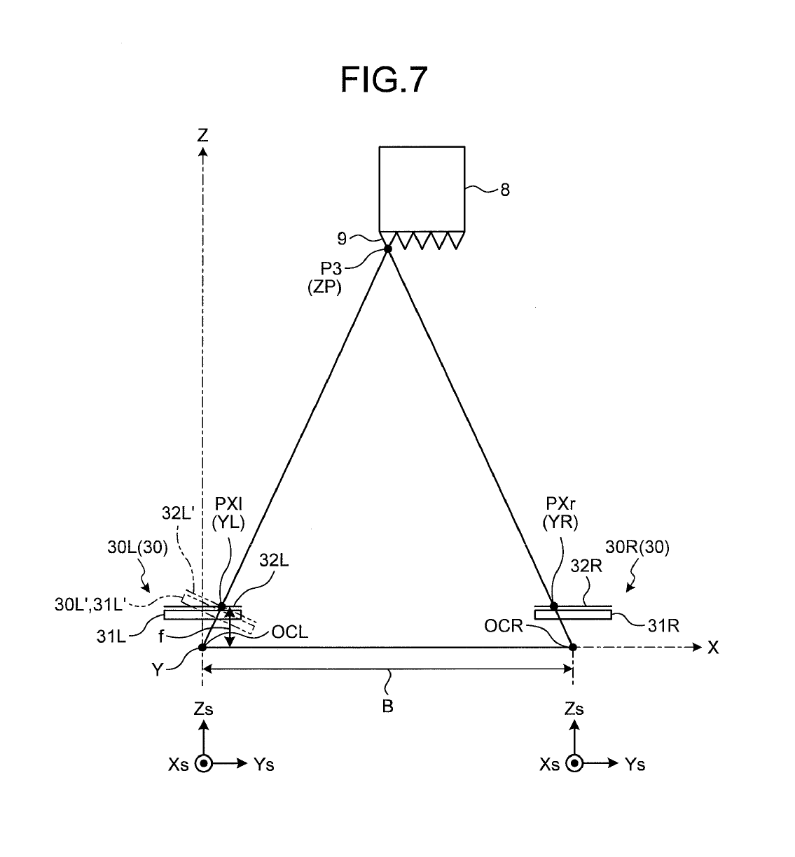

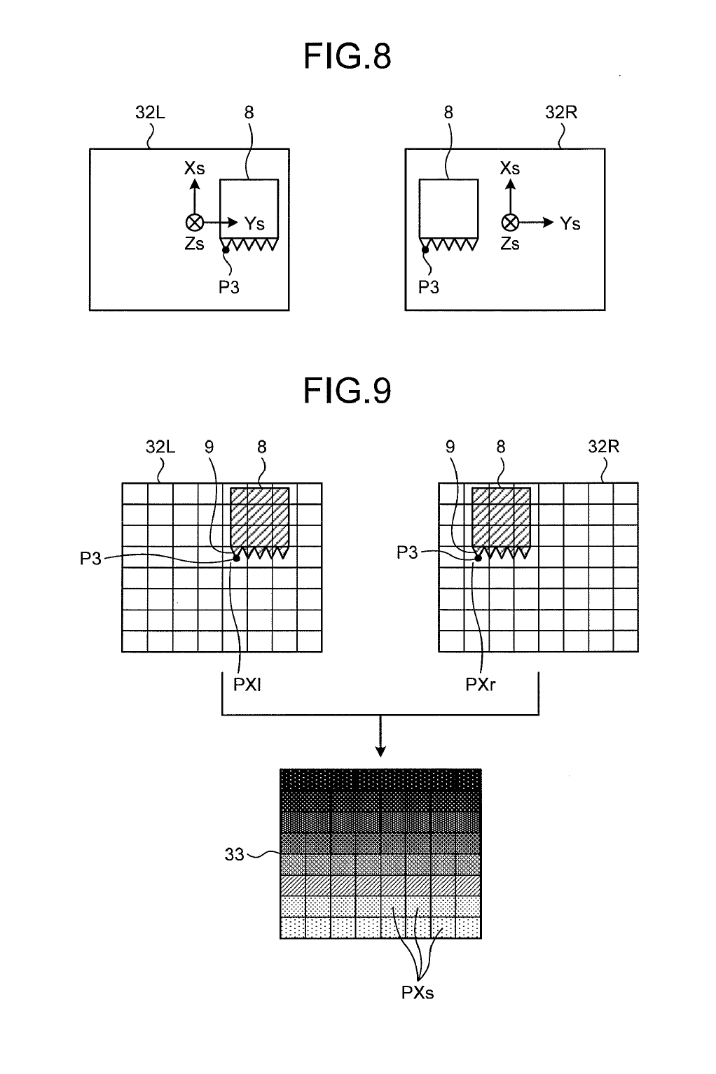

FIG. 7 is a diagram for describing an example in which the blade edge P3 of the blade 9 of the bucket 8 is measured in the three-dimensional manner using a pair of image pickup apparatuses 30L and 30R. FIGS. 8 and 9 are diagrams illustrating a pair of images 32L and 32R obtained by the pair of image pickup apparatuses 30L and 30R. In the embodiment, the processing apparatus 20 illustrated in FIG. 6 obtains the position of the object by performing the stereoscopic image processing on the pair of images picked up by the pair of image pickup apparatuses 30. In FIG. 7, the pair of image pickup apparatuses 30 picking up the blade edge P3 is referred to as the image pickup apparatus 30L and the image pickup apparatus 30R. The pair of image pickup apparatuses 30L and 30R are the image pickup apparatuses 30 of the excavator 100 illustrated in FIG. 2. FIG. 7 illustrates a state where the position of the image pickup apparatus 30L is moved by some external factors as an image pickup apparatus 30L′ depicted by a two-dotted chain line.

The image pickup apparatus 30L includes an image pickup element 31L. The original point of the image pickup apparatus coordinate system (Xs, Ys, Zs) of the image pickup apparatus 30L (that is, the center of the image pickup apparatus 30L) is set as an optical center OCL. The Zs axis of the image pickup apparatus 30L is an optical axis of the image pickup apparatus 30L, and passes through the optical center OCL. When picking up the object, the image pickup apparatus 30L obtains an image 32L containing the object. The image pickup apparatus 30R includes an image pickup element 31R. The original point of the image pickup apparatus coordinate system (Xs, Ys, Zs) of the image pickup apparatus 30R (that is, the center of the image pickup apparatus 30R) is set as an optical center OCR. The Zs axis of the image pickup apparatus 30R is an optical axis of the image pickup apparatus 30R, and passes through the optical center OCR. When picking up the object, the image pickup apparatus 30R obtains an image 32R containing the object.

In the embodiment, the object of which the position is obtained by the stereoscopic method is the blade edge P3 of the bucket 8 illustrated in FIG. 7. When the image pickup apparatus 30L and the image pickup apparatus 30R pick up the image of the bucket 8, the pair of images 32L and 32R as illustrated in FIG. 8 are obtained. The image pickup apparatus 30L is disposed on the left side to face the bucket 8, and the image pickup apparatus 30R is disposed on the right side to face the bucket 8 to be separated from the image pickup apparatus 30L by a predetermined distance B. As illustrated in FIG. 8, the position of the blade edge P3 of the bucket 8 in the image 32L picked up by the image pickup apparatus 30L and the position of the blade edge P3 of the bucket 8 in the image 32R picked up by the image pickup apparatus 30R are different in the arranging direction of the image pickup apparatus 30L and the image pickup apparatus 30R. In this way, since the image pickup apparatus 30L and the image pickup apparatus 30R are disposed to be separated by a predetermined distance, the direction viewing the object is different depending on a positional difference of the observation point of the object.

The processing apparatus 20 performs the stereoscopic image processing on the image 32L of the blade edge P3 of the bucket 8 picked up by the image pickup apparatus 30L and the image 32R of the blade edge P3 of the bucket 8 picked up by the image pickup apparatus 30R. The position of the blade edge P3 of the bucket 8 (the same object) is measured in the three-dimensional manner by the stereoscopic image processing. The stereoscopic image processing includes a process of generating a parallax image 33 based on the pair of images 32L and 32R, and a process of measuring a space of the pickup range of the image pickup apparatuses 30L and 30R in the three-dimensional manner based on parallax information contained in the parallax image 33.

In the process of generating the parallax image 33, as illustrated in FIG. 9, the processing apparatus 20 searches the corresponding portions between the pair images 32L and 32R (images PX1 and PXr corresponding to the blade edge P3 in the embodiment), and obtains parallax from the searching result of the corresponding images PX1 and PXr. The parallax is information indicating a physical distance between the images PX1 and PXr corresponding to the blade edge P3 (for example, the number of pixels between the images). The parallax image 33 is an image obtained by expressing the parallax in a two-dimensional arrangement.

Further, the parallax is generally defined by a variation amount in angle formed between the line-of-sights of the pair of image pickup apparatuses 30 with the measurement object as a reference. In a case where the pair of image pickup apparatuses 30 are arrange in parallel, the parallax is the pixel amount deviated in the pickup image in which the projected point of the same measurement point in the image of the other image pickup apparatus 30 is deviated from the projected point of the measurement point in the image of the reference image pickup apparatus.

The parallax image 33 stores “0” in an image PXs failed in searching in a case where the searching of the corresponding images fails, and stores a value larger than “0” in an image PXs succeeding in searching in a case where the searching succeeds. In the parallax image 33, the image PXs stored with “0” becomes black, and the image PXs stored with the value larger than “0” becomes a gray scale. Therefore, in order to confirm whether the stereoscopic image processing succeeds, a ratio occupied by the image PXs stored with a value other than “0” in the parallax image 33 may be used. For example, when a ratio of the image PXs in the gray scale (that is, the image PXs stored with a value other than “0”) occupied in the parallax image 33 is equal to or more than a threshold, it is determined that the stereoscopic image processing succeeds. The threshold is, for example, may be set to 80% to 90%, and the invention is not limited to this range.

The processing apparatus 20 obtains a distance to the object using triangulation in the process of the three-dimensional measurement. As illustrated in FIG. 7, a three-dimensional coordinate system (X,Y,Z) is provided with the optical center OCL of the image pickup apparatus 30L as the original point. The image pickup apparatus 30L and the image pickup apparatus 30R are assumed to be disposed in parallel. In other words, the image pickup apparatus 30L and the image pickup apparatus 30R are assumed to be disposed such that the imaging surfaces of the images 32L and 32R become flush with each other and at the same position in the X axis direction. A distance between the optical center OCL of the image pickup apparatus 30L and the optical center OCR of the image pickup apparatus 30R is set to B, the Y-axis coordinate of the blade edge P3 (that is, the image PX1) in the image 32L picked up by the image pickup apparatus 30L is set to YL, the Y-axis coordinate of the blade edge P3 in the image 32R (that is, the image PXr) picked up by the image pickup apparatus 30R is set to YR, and the Z-axis coordinate of the blade edge P3 is set to ZP. YL, YR, and ZP are all coordinates in the three-dimensional coordinate system (X,Y,Z). A distance between the Y axis and the imaging surfaces of the images 32L and 32R is the focal distance f of the image pickup apparatuses 30L and 30R.

In this case, the distance from the image pickup apparatuses 30L and 30R to the blade edge P3 become the Z-axis coordinate ZP of the blade edge P3 in the three-dimensional coordinate system (X,Y,Z). When the parallax is set to d=YL−(YR−B), the ZP is obtained by B× f/d.

In each pixel PXs of the parallax image 33 illustrated in FIG. 9, information indicating success/failure in the searching and the parallax d in a case where the searching succeeds are stored. The processing apparatus 20 can obtain the distance to the object based on the parallax d between the respective pixels which succeed in the searching in the images 32L and 32R succeeding in the searching, the coordinates of the respective pixels which succeed in the searching in the images 32L and 32R, and the focal distance f of the image pickup apparatuses 30L and 30R.

In the example illustrated in FIG. 9, the processing apparatus 20 searches the image corresponding between the pair of images 32L and 32R, and generates the parallax image 33. Next, the processing apparatus 20 searches the images PX1 and PXr corresponding to the blade edge P3 which is the object to obtain the distance. When the images PX1 and PXr corresponding to the blade edge P3 are searched between the pair of images 32L and 32R, the processing apparatus 20 obtains the Y-axis coordinates YL and YR of the searched images PX1 and PXr. The processing apparatus 20 substitutes the obtained coordinates YL and YR and the distance B into the equation d=YL−(YR−B) of the parallax d to obtain the parallax d. The processing apparatus 20 obtains the distance ZP from the image pickup apparatuses 30L and 30R to the blade edge P3 by substituting the obtained parallax d, the distance B, and the focal distance f into the above equation.

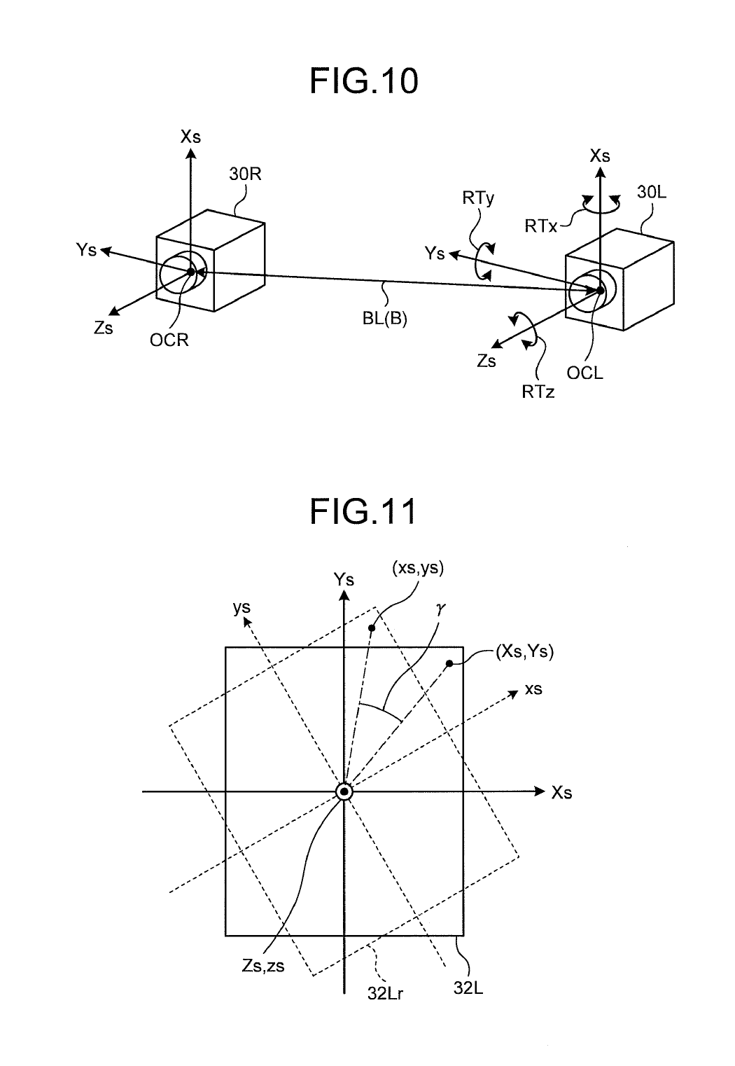

FIG. 10 is a perspective view illustrating a positional relation of the pair of image pickup apparatuses 30L and 30R. The pair of image pickup apparatuses 30L and 30R are configured by the stereo cameras. For the convenience of explanation, in a case where the object is measured in the three-dimensional manner using the pair of image pickup apparatuses 30L and 30R, one image pickup apparatus 30R is set as a primary apparatus, and the other image pickup apparatus 30L is set as a secondary apparatus. The straight line connecting the optical center OCR of the image pickup apparatus 30R and the optical center OCL of the image pickup apparatus 30L is a base line BL. The length of the base line BL is B.

In a case where the image pickup apparatus 30L is not disposed in parallel to the image pickup apparatus 30R, the corresponding image between the pair of images 32L and 32R may be not searched. Therefore, a relative positional relation between the image pickup apparatus 30L and the image pickup apparatus 30R is obtained in advance. Then, the stereoscopic image processing and the three-dimensional measurement can be made by correcting at least one of the images 32L and 32R based on the deviation between the image pickup apparatus 30L and the image pickup apparatus 30R obtained from the relative positional relation.

The deviation between the image pickup apparatus 30L and the image pickup apparatus 30R can be expressed by a deviation of the secondary apparatus with respect to the primary apparatus (that is, a deviation of the image pickup apparatus 30L with respect to the image pickup apparatus 30R). Therefore, there are deviations in six directions in total such as a rotation RTx about the Xs axis of the image pickup apparatus 30L, a rotation RTy about the Ys axis of the image pickup apparatus 30L, a rotation RTz about the Zs axis of the image pickup apparatus 30L, a deviation in the Xs axis direction of the image pickup apparatus 30L, a deviation in the Ys axis direction of the image pickup apparatus 30L, and a deviation in the Zs axis direction of the image pickup apparatus 30L.

FIG. 11 is a diagram for describing the deviation of the image pickup apparatus 30R with respect to the image pickup apparatus 30L. As illustrated in FIG. 11, for example, in a case where the rotation RTz occurs about the Zs axis of the image pickup apparatus 30L in the image pickup apparatus 30L, an image 32Lr obtained from the posture of the image pickup apparatus 30L in the case of the deviation is rotated about the Zs axis by the amount of deviation caused by the rotation Rty, so that the image 32L of the image pickup apparatus 30L in the case of no deviation can be corrected.

The deviation caused by the rotation RTz can be expressed by an angle γ about the Zs axis. Therefore, the position (xs, ys) in an xs-ys plane of the image 32Lr of the image pickup apparatus 30L is rotated about the Zs axis using Equation (1) so as to be converted into the position (Xs, Ys) in an Xs-Ys plane of the image 32L of the image pickup apparatus 30L in the case of no deviation.

$$( \begin{matrix}Xs \\ Ys\end{matrix} ) = ( \begin{matrix}cos γ & - sin γ \\ sin γ & cos γ\end{matrix} ) ( \begin{matrix}xs \\ ys\end{matrix} ) \qquad ( 1 )$$

Similarly to the rotation RTz about the Zs axis, the deviation caused by the rotation RTx about the Xs axis is corrected by Equation (2), and the deviation caused by the rotation RTy about the Ys axis is corrected by Equation (3). An angle α in Equation (2) indicates the deviation caused by the rotation RTx, and an angle β in Equation (3) indicates the deviation caused by the rotation RTy. The angles α, β, and γ are quantities to correct the deviations in the rotation directions about the axes in the image pickup apparatus coordinate system of the image pickup apparatus 30L. Hereinafter, the angles α, β, and γ will be appropriately referred to as rotation direction correction quantities α, β, and γ, or simply as the rotation direction correction quantity.

$$\begin{matrix}( \begin{matrix}Ys \\ Zs\end{matrix} ) = ( \begin{matrix}cos α & - sin α \\ sin α & cos α\end{matrix} ) ( \begin{matrix}ys \\ zs\end{matrix} ) & ( 2 ) \\ ( \begin{matrix}Xs \\ Zs\end{matrix} ) = ( \begin{matrix}cos β & sin β \\ - sin β & cos β\end{matrix} ) ( \begin{matrix}xs \\ ys\end{matrix} ) & ( 3 )\end{matrix}$$

The deviation of the image pickup apparatus 30L generated in the Xs axis direction of the image pickup apparatus 30R is corrected by moving the position of the image 32Lr picked up by the image pickup apparatus 30L by an deviation cancelling quantity ΔX in parallel to the Xs axis direction of the image pickup apparatus 30R. The deviations of the image pickup apparatus 30L generated in the Ys axis direction and the Zs axis direction of the image pickup apparatus 30R are also corrected similarly to the deviation cancelling quantity ΔX of the image pickup apparatus 30L generated in the Xs axis direction. In other words, the position of the image 32Lr picked up by the image pickup apparatus 30L is moved by the deviation cancelling quantities ΔY and ΔZ in parallel to the Ys axis direction and the Zs axis direction of the image pickup apparatus 30R. The deviation cancelling quantities ΔX, ΔY, and ΔZ are quantities for correcting the deviations in a translation direction of the pair of image pickup apparatuses 30. Hereinafter, the deviation cancelling quantities ΔX, ΔY, and ΔZ will be appropriately referred to as the translation direction correction quantities ΔX, ΔY, and ΔZ or simply as the translation direction correction quantity.

The obtaining of the rotation direction correction quantities α, β, and γ and the translation direction correction quantities ΔX, ΔY, and ΔZ in order to correct the deviation of the pair of the image pickup apparatus 30R and the image pickup apparatus 30L of the stereo camera is referred to as an external correction. The external correction is performed, for example, at the time of releasing the excavator 100. The rotation direction correction quantities α, β, and γ and the translation direction correction quantities ΔX, ΔY, and ΔZ obtained in the external correction are parameters for defining the posture of the image pickup apparatus 30. Hereinafter, these parameters will be appropriately referred to as posture parameters. The posture parameters are six-dimensional parameters. The posture parameters obtained in the external correction are stored in the storage unit 22 of the processing apparatus 20 illustrated in FIG. 6. The processing apparatus 20 performs the stereoscopic image processing on the image picked up by at least the pair of image pickup apparatuses 30 using the posture parameters stored in the storage unit 22, and measures the pickup image in the three-dimensional manner.

At least the pair of image pickup apparatuses 30 of the excavator 100 illustrated in FIG. 2 are corrected in deviation of the relative positional relation after being attached to the excavator 100 through the above-described method. In a case where the image pickup apparatus 30 corrected after being attached to the excavator 100 is physically moved by some external factors, the posture parameter before the image pickup apparatus 30 is moved and the actual posture of the image pickup apparatus 30 may does not correspond to each other.

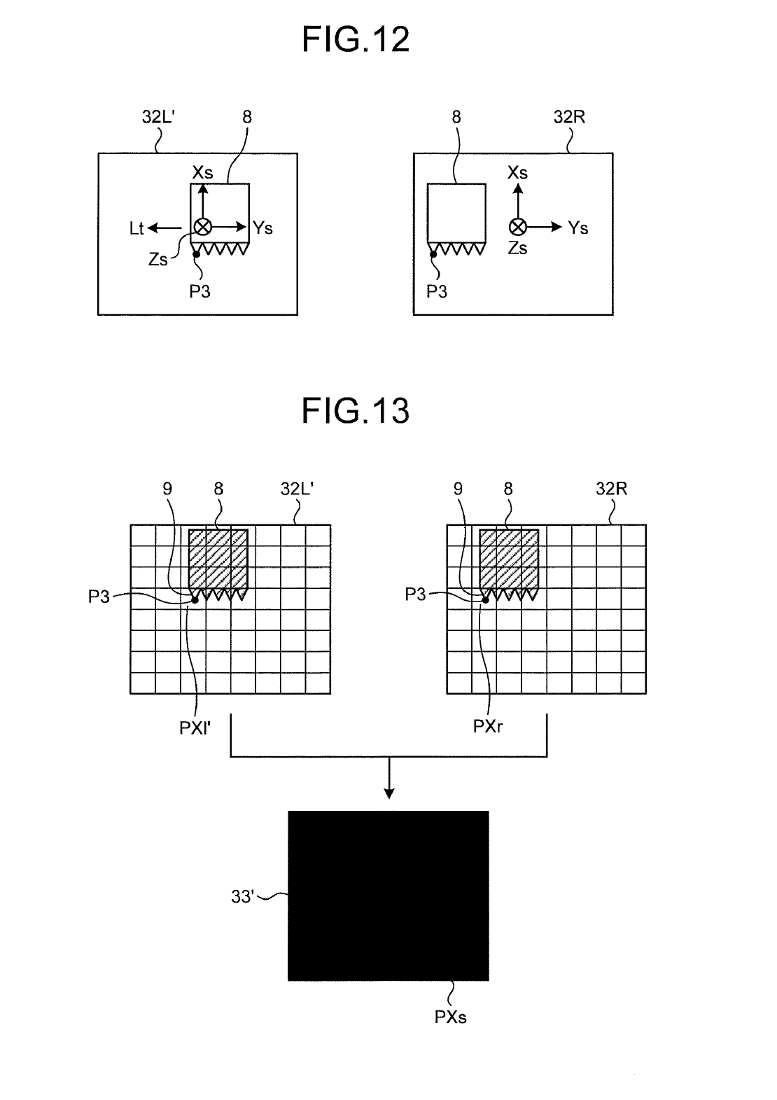

FIGS. 12 and 13 are diagrams illustrating the pair of images 32L and 32R obtained by the pair of image pickup apparatuses 30L and 30R. FIGS. 12 and 13 illustrate the pair of images 32L′ and 32R which are picked up by the image pickup apparatus 30R illustrated in FIG. 7 and the image pickup apparatus 30L′ moved by some external factors. The image pickup apparatus 30L′ illustrated in FIG. 7 shows that the image pickup apparatus 30L disposed in parallel to the image pickup apparatus 30R is rotated about the Xs axis of the image pickup apparatus coordinate system for example so as to be rotated in a direction where the image pickup surface of an image pickup element 31L′ faces the image pickup apparatus 30R.

As illustrated in FIGS. 12 and 13, the image 32L′ picked up by the image pickup apparatus 30L′ in this state is compared to the image 32L picked up by the image pickup apparatus 30L which is not moved by some external factors, the position of the blade edge P3 of the bucket 8 is moved in a direction depicted by an arrow Lt (that is, the left side of the image 32L). In this state, even when the processing apparatus 20 searches an image PX1′ and the image PXr corresponding to the blade edge P3 between the pair of images 32L′ and 32R, it is not possible to find out the images. Therefore, as illustrated in FIG. 13, the parallax image 33′ obtained by the searching between the pair of images 32L′ and 32R may contain the ratio occupied by “0” which indicates that the corresponding image fails in searching. As a result, in the parallax image 33′, the ratio occupied by the gray-scaled image in the entire image becomes low, and the ratio occupied by the black image PXs becomes high. Therefore, the three-dimensional measurement by the stereoscopic method is not possible.

In a case where the image pickup apparatus 30 is moved by some external factors, the posture parameter may be obtained again by the external correction, but it takes time and trouble in the installation of equipment for the external correction and the work for the external correction. In a case where the posture of the image pickup apparatus 30 is changed, the correction system 50 illustrated in FIG. 6 performs the correction method according to the embodiment to obtain the posture parameter again, automatically corrects the deviation among the plurality of image pickup apparatuses 30, and recovers the three-dimensional measurement by the stereoscopic method. Hereinafter, the process will be appropriately referred to as an automatic correction.

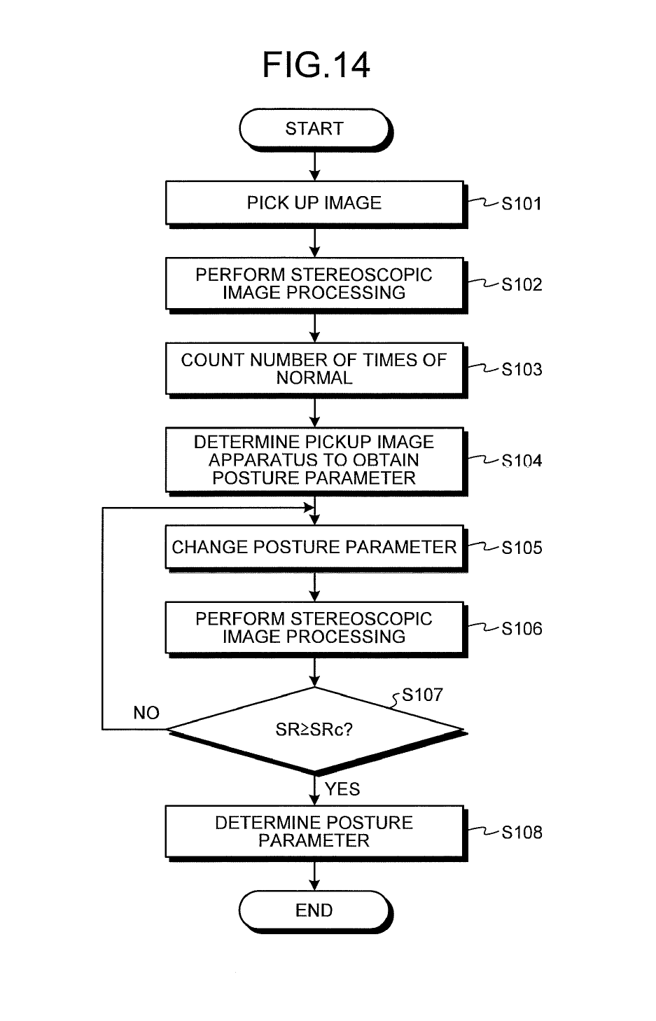

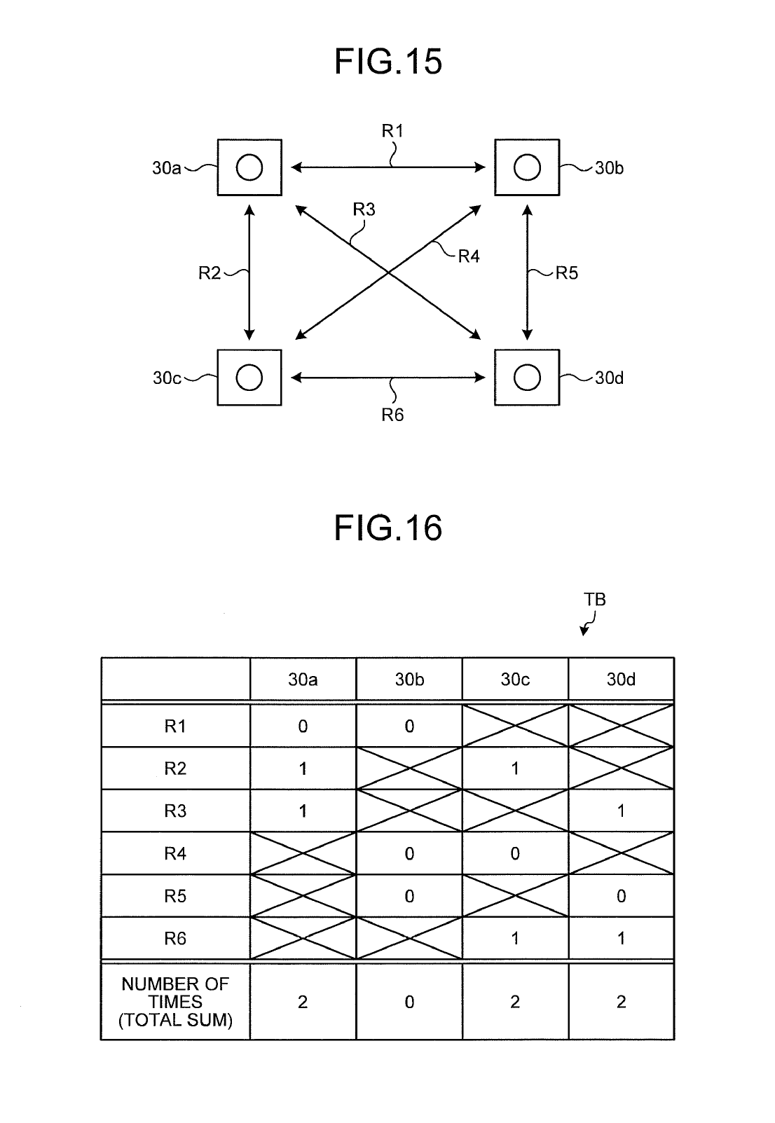

FIG. 14 is a flowchart illustrating a process when the correction system 50 according to the embodiment performs the correction method according to the embodiment. FIG. 15 is a diagram for describing a method of determining the image pickup apparatus to obtain the posture parameter. FIG. 16 is a diagram illustrating an example of a table for determining the image pickup apparatus to obtain the posture parameter. In Step S101, the processing apparatus 20 causes all the plurality of image pickup apparatuses 30 illustrated in FIG. 2 to pick up the object. The object may be the bucket 8, but the invention is not limited thereto.

In Step S102, the processing apparatus 20 performs the stereoscopic image processing on the images picked up in Step S101. Specifically, the stereoscopic image processing is performed on the images picked up by the pair of image pickup apparatuses 30 of the stereo camera. The image processing is a processing to generate a parallax image from the pair of images. In Step S102, the processing apparatus 20 generates the parallax images from all the pairs of images obtained by all the combinations of the stereo camera among the plurality of image pickup apparatuses 30 of the excavator 100.

In the embodiment, the excavator 100 includes four image pickup apparatuses 30a, 30b, 30c, and 30d. In the example illustrated in FIG. 15, the processing apparatus 20 generates the parallax images from six pairs of images obtained from six combinations R1, R2, R3, R4, R5, and R6 as follows.

R1: the image pickup apparatus 30a and the image pickup apparatus 30b

R2: the image pickup apparatus 30a and the image pickup apparatus 30c

R3: the image pickup apparatus 30a and the image pickup apparatus 30d

R4: the image pickup apparatus 30b and the image pickup apparatus 30c

R5: the image pickup apparatus 30b and the image pickup apparatus 30d

R6: the image pickup apparatus 30c and the image pickup apparatus 30d

When the parallax images are generated by the above-described six combinations, the image pickup apparatuses 30a, 30b, 30c, and 30d each will generate the parallax images three times. In the embodiment, in a case where the ratio of the gray-scaled pixels occupying in the parallax image is equal to or more than a threshold, it is determined that the parallax image is normal. The magnitude of the threshold is the same as described above.

In the six combinations R1 to R6, the pair of image pickup apparatuses 30 configured by a combination generating a normal parallax image even once does not cause the deviation. Since the image pickup apparatus 30 to obtain the posture parameter is determined from the six parallax images obtained by the six combinations R1 to R6, the processing apparatus 20 uses, for example, a determination table TB illustrated in FIG. 16. The determination table TB stores the storage unit 22 of the processing apparatus 20 therein.

In the determination table TB, the image pickup apparatus 30 corresponding to the combination generating the normal parallax image is written by “1”, and the image pickup apparatus 30 corresponding to the combination not generating the normal parallax image is written by “0”. Then, a total sum in the determination table TB is written by a total number of times when the each of image pickup apparatuses 30a, 30b, 30c, and 30d writes “1”. In this way, the determination table TB can show the number of times when the normal parallax images are generated by the image pickup apparatuses 30a, 30b, 30c, and 30d. The processing unit 21 writes the values in the determination table TB.

In the determination table TB, “1” or “0” is written according to the rules below.

(1) In a case where the parallax image generated by a combination R1 is normal, “1” is written for the image pickup apparatuses 30a and 30b.

(2) In a case where the parallax image generated by a combination R2 is normal, “1” is written for the image pickup apparatuses 30a and 30c.

(3) In a case where the parallax image generated by a combination R3 is normal, “1” is written for the image pickup apparatuses 30a and 30d.

(4) In a case where the parallax image generated by a combination R4 is normal, “1” is written for the image pickup apparatuses 30b and 30c.

(5) In a case where the parallax image generated by a combination R5 is normal, “1” is written for the image pickup apparatuses 30b and 30d.

(6) In a case where the parallax image generated by a combination R6 is normal, “1” is written for the image pickup apparatuses 30c and 30d.

The determination table TB illustrated in FIG. 16 shows a case where the parallax images generated by the combinations R2, R3, and R6 are normal and the parallax images generated by the combinations R1, R4, and R5 are not normal. In this case, the number of times when “1” is written in the image pickup apparatuses 30a, 30c, and 30d is respectively two as denoted in the total sum of the determination table TB, and the number of times when “1” is written in the image pickup apparatus 30b is zero. Since there occurs a deviation not allowable to the image pickup apparatuses 30a, 30c, and 30d, the image pickup apparatus 30b determines that there is no normal combination even once. Therefore, the image pickup apparatus 30b becomes the object to obtain the posture parameter. In this way, the determination table TB determines the image pickup apparatus 30 to obtain the posture parameter using the number of times when “1” is written (that is, the number of times when the normal parallax image is generated from the pickup image result of the image pickup apparatus 30). In other words, the processing apparatus 20 determines the pair of image pickup apparatuses 30 to obtain the posture parameter based on the parallax image as a result of searching the corresponding portion between the pair of images obtained by the pair of image pickup apparatuses 30 in at least two image pickup apparatuses 30. The method of determining the pair of image pickup apparatuses 30 to obtain the posture parameter described in the embodiment is an example, and the invention is not limited thereto.

In Step S103, the processing apparatus 20 uses the determination table TB to count the number of times when the normal parallax images is generated for each of the image pickup apparatuses 30a, 30b, 30c, and 30d. In Step S104, the processing apparatus 20 determines the image pickup apparatus 30 to obtain the posture parameter again due to the deviation based on the number of times when the normal parallax image is generated. In this way, in a case where there are a plurality of pairs of image pickup apparatuses 30, the processing apparatus 20 obtains the posture parameter of at least one of the pair of image pickup apparatuses 30 which has a success rate of the searching is less than a threshold (that is, the normal parallax image) again.

When the image pickup apparatus 30 to obtain the posture parameter again is determined, the processing apparatus 20 performs a process of obtaining the posture parameter. In Step S105, the processing apparatus 20 (the search unit 21A of the processing unit 21 in this embodiment) changes the posture parameter. Then, in Step S106, the search unit 21A of the processing apparatus 20 performs the stereoscopic image processing on the pair of images picked up by the image pickup apparatus 30 to obtain the posture parameter again and the paired image pickup apparatus 30 using the changed posture parameter. The pair of images subjected to the stereoscopic image processing are the images picked up in Step S101. Specifically, the stereoscopic image processing is a process of generating the parallax image from the pair of images.

When the process of Step S106 is ended, the processing apparatus 20 (the determination unit 21B of the processing unit 21 in this embodiment) compares, in Step S107, a gray scale ratio SR which is a ratio of the gray-scaled pixels occupying the parallax image generated in Step S106 (that is, the image stored with a value other than “0”) with a threshold SRc. The process of Step S107 is a process of determining the success rate of the stereoscopic image processing. As described above, the magnitude of the threshold SRc may be set from 80% to 90% for example, but the invention is not limited to the value in the range. In Step S107, in a case where the gray scale ratio SR is less than the threshold SRc (Step S107, No), the determination unit 21B of the processing apparatus 20 returns the procedure to Step S105, and repeatedly performs the processes from Step S105 to Step S107 until the gray scale ratio SR is equal to or more than the threshold SRc.

In Step S107, in a case where the gray scale ratio SR of the parallax image is equal to or more than the threshold SRc (Step S107, Yes), the determination unit 21B of the processing apparatus 20 determines the posture parameter at this time as a new posture parameter in Step S108. Thereafter, the stereoscopic image processing is performed using the posture parameter determined in Step S108.

In the embodiment, the processing apparatus 20 changes the posture parameter of one of the pair of image pickup apparatuses 30 as the objects of which the posture parameter is changed, and does not change the posture parameter of the other one. Therefore, the stereoscopic image processing is performed on the pair of images picked up by these apparatuses. The relative positional relation of the pair of image pickup apparatuses 30 can be quickly approached to a state before the deviation occurs by changing the posture parameter of one of the pair of image pickup apparatuses 30, compared to a case where both the posture parameters are changed. As a result, the processing apparatus can shorten the time taken for obtaining a new posture parameter.

In the pair of image pickup apparatuses 30 of which the posture parameter is changed, an apparatus of which the posture parameter is not changed will be referred to as the first image pickup apparatus, and an apparatus of which the posture parameter is changed will be referred to as the second image pickup apparatus. In this example, the objects of which the posture parameter is changed are the image pickup apparatus 30c and the image pickup apparatus 30d illustrated in FIG. 2, and the posture parameter of the image pickup apparatus 30d is changed. Therefore, the image pickup apparatus 30c is the first image pickup apparatus, and the image pickup apparatus 30d is the second image pickup apparatus. Hereinafter, the image pickup apparatus 30c will be appropriately referred to as the first image pickup apparatus 30c, and the image pickup apparatus 30d will be appropriately referred to as the second image pickup apparatus 30d.

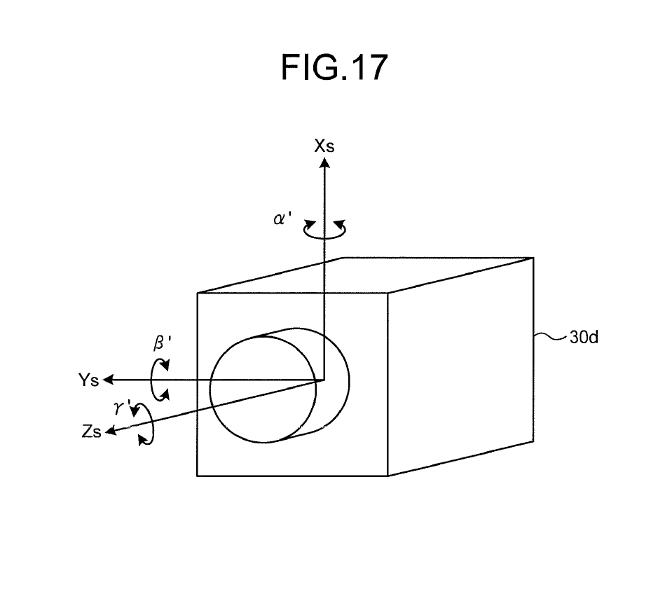

FIGS. 17 to 21 are diagrams for describing the posture parameter. As described above, the posture parameter includes the rotation direction correction quantities α, β, and γ and the translation direction correction quantities ΔX, ΔY, and ΔZ. When a new posture parameter is obtained, the processing apparatus 20 changes a first parameter which defines the positional relation in the translation direction of the first image pickup apparatus 30c and the second image pickup apparatus 30d, and a second parameter which defines the posture in the image pickup apparatus coordinate system of the second image pickup apparatus 30d. The first parameter and the second parameter (that is, the parameters defining the posture of the second image pickup apparatus 30d) indicate the rotation of the second image pickup apparatus 30d. The processing apparatus 20 changes the posture parameter such as the rotation direction correction quantities α, β, and γ and the translation direction correction quantities ΔX, ΔY, and ΔZ by changing the first parameter and the second parameter.

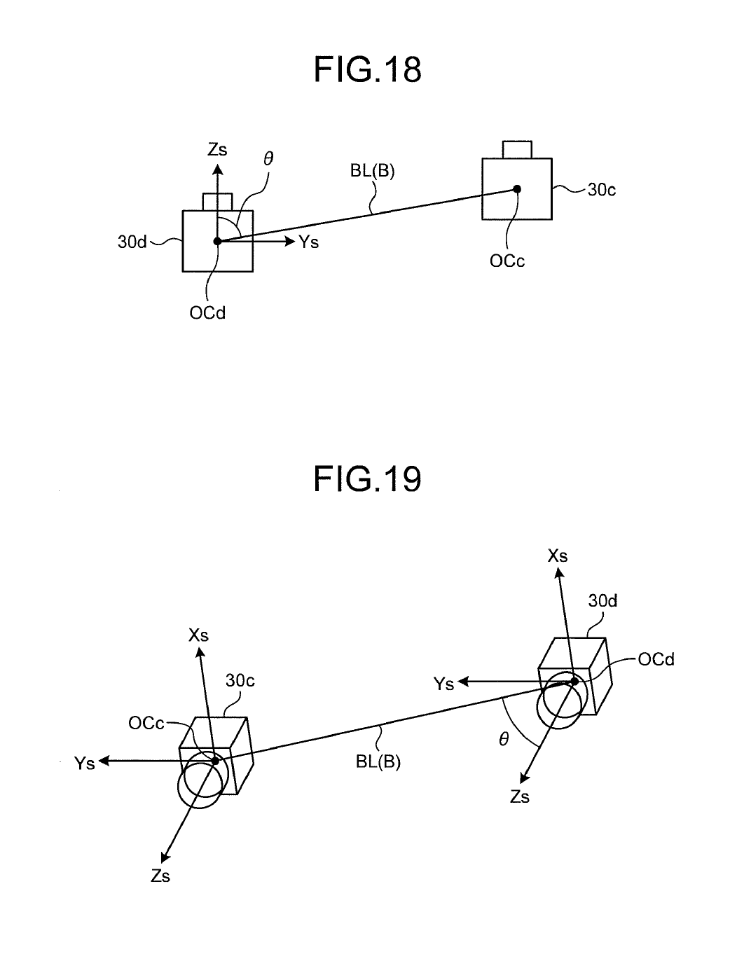

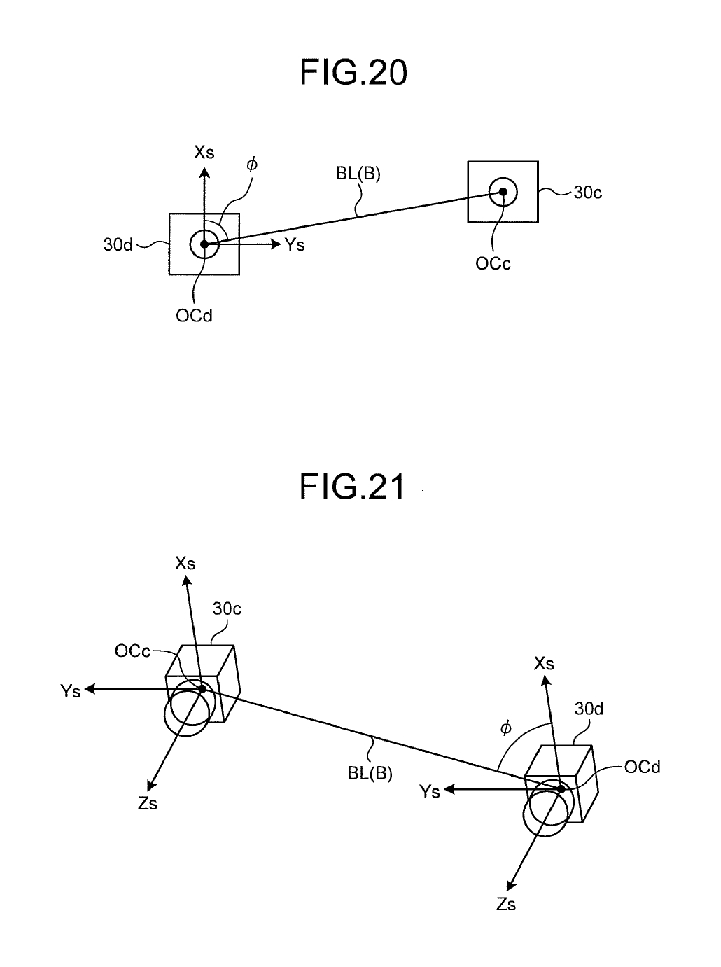

As described in the following, the second parameter includes angles α′, β′, and γ′ as illustrated in FIG. 17. The angles α′, β′, and γ′ are rotation angles of the second image pickup apparatus 30d in the respective axes of the image pickup apparatus coordinate system (Xs, Ys, Zs) of the second image pickup apparatus 30d. The first parameter includes an angle θ illustrated in FIGS. 18 and 19, and an angle φ illustrated in FIGS. 20 and 21. The angle θ is an angle formed by the base line BL and the Zs axis of the image pickup apparatus coordinate system (Xs, Ys, Zs) of the second image pickup apparatus 30d. The angle φ is an angle formed by the base line BL and the Xs axis of the image pickup apparatus coordinate system (Xs, Ys, Zs) of the second image pickup apparatus 30d.

When the angle θ and the angle φ of the first parameter are changed, the second image pickup apparatus 30d rotates about the first image pickup apparatus 30c (more specifically, the original point (matched with an optical center OCc in this example) of the image pickup apparatus coordinate system of the first image pickup apparatus 30c). In other words, the first parameter causes the second image pickup apparatus 30d to rotate about the first image pickup apparatus 30c.

When the angles α′, β′, and γ′ of the second parameter are changed, the second image pickup apparatus 30d rotates about itself (more specifically, the original point (matched with an optical center OCd in this example) of the image pickup apparatus coordinate system of the second image pickup apparatus 30d). In other words, the second parameter causes the second image pickup apparatus 30d to rotate about the second image pickup apparatus 30d.

In this way, the first parameter and the second parameter both are parameters to define the posture of the second image pickup apparatus 30d. The relative positional relation between the first image pickup apparatus 30c and the second image pickup apparatus 30d are defined by defining the posture of the second image pickup apparatus 30d.

In the embodiment, the processing apparatus 20 changes the parameters to define the posture of the second image pickup apparatus 30d such that a distance between the first image pickup apparatus 30c and the second image pickup apparatus 30d is constant (that is, the length B of the base line BL between the first image pickup apparatus 30c and the second image pickup apparatus 30d is set to be constant. The base line BL between the first image pickup apparatus 30c and the second image pickup apparatus 30d is a straight line connecting the optical center OCc of the first image pickup apparatus 30c and the optical center OCd of the second image pickup apparatus 30d.

When the angle θ and the angle φ of the first parameter are changed while setting the length of the base line BL constant, the second image pickup apparatus 30d rotates about the first image pickup apparatus 30c. As a result, the translation component of the second image pickup apparatus 30d is also changed in addition to the rotation component of the second image pickup apparatus 30d. Therefore, the rotation direction correction quantities α, β, and γ and the translation direction correction quantities ΔX, ΔY, and ΔZ of the posture parameter are changed by changing the first parameter and the second parameter. The number of parameters to be changed for obtaining the posture parameter can be reduced by changing the angle θ and the angle φ of the first parameter while setting the length of the base line BL constant. As a result, it is preferable that the calculation load of the processing apparatus 20 is reduced.

When the angles θ and φ of the first parameter and the angles α′, β′, and γ′ of the second parameter are obtained, the relative positional relation between the first image pickup apparatus 30c and the second image pickup apparatus 30d is obtained. The processing apparatus 20 generates the parallax image while changing the first parameter and the second parameter until the gray scale ratio SR of the parallax image increased to be equal to or more than the threshold SRc. When the first parameter and the second parameter are changed, the processing apparatus 20 changes the angles θ and φ and the angles α′, β′, and γ′ by a predetermined amount of change in both positive and negative directions until the angles reach predetermined quantities with the values before the change as a reference. FIGS. 17 to 21 illustrate examples in which the angles θ and φ and the angles α′, β′, and γ′ are changed in the positive direction and the negative direction.

The processing apparatus 20 generates the parallax image from the pair of images picked up by the first image pickup apparatus 30c and the second image pickup apparatus 30d using the changed angles θ and φ and the changed angles α′, β′, and γ′ whenever the angles θ and φ and the angles α′, β′, and γ′ are changed. Specifically, the processing apparatus 20 obtains the rotation direction correction quantities α, β, and γ and the translation direction correction quantities ΔX, ΔY, and ΔZ of the posture parameter using the changed angles θ and φ and the changed angles α′, β′, and γ′, and generates the parallax image using the obtained posture parameter. The processing apparatus 20 compares the gray scale ratio SR of the generated parallax image and the threshold SRc.

The processing apparatus 20 obtains the rotation direction correction quantities α, β, and γ and the translation direction correction quantities ΔX, ΔY, and ΔZ of the posture parameter using the first parameter and the second parameter when the gray scale ratio SR of the parallax image is equal to or more than the threshold SRc. Then, the stereoscopic image processing is performed on the image picked up by the image pickup apparatus 30 using the newly obtained rotation direction correction quantities α, β, and γ and the newly obtained translation direction correction quantities ΔX, ΔY, and ΔZ, and the three-dimensional measurement is performed.

The description will be made in a case where three image pickup apparatuses 30 of the plurality of image pickup apparatuses 30 are the objects to change the posture parameter. In a case where three image pickup apparatuses 30b, 30c, and 30d illustrated in FIG. 15 are the objects to change the posture parameter, there are three combinations (that is, the combination of the image pickup apparatus 30c and the image pickup apparatus 30b, the combination of the image pickup apparatus 30c and the image pickup apparatus 30d, and the combination of the image pickup apparatus 30d and the image pickup apparatus 30b). In this case, one apparatus of three image pickup apparatuses 30b, 30c, and 30d is set to the first image pickup apparatus, and the left two apparatuses are set to the second image pickup apparatus. Then, since two pairs of image pickup apparatuses are established with the first image pickup apparatus as a common apparatus, the processing apparatus 20 obtains a new posture parameter for each combination.

For example, the image pickup apparatus 30c is set to the first image pickup apparatus, and the image pickup apparatuses 30b and 30d are set to the second image pickup apparatus. Then, the combination of the image pickup apparatus 30c and the image pickup apparatus 30b, and the combination of the image pickup apparatus 30c and the image pickup apparatus 30d are established. The processing apparatus 20 changes the posture parameter of the image pickup apparatus 30b with respect to the formal combination, and changes the posture parameter of the image pickup apparatus 30d with respect to the latter combination.

The method of obtaining the posture parameter in a case where three image pickup apparatuses 30 change the posture parameter is not limited to the above method. For example, the processing apparatus 20 may determine first the posture parameter of the image pickup apparatus 30b in the combination of the image pickup apparatus 30c and the image pickup apparatus 30b, and then set the image pickup apparatus 30b as the first image pickup apparatus and the image pickup apparatus 30d as the second image pickup apparatus so as to determine the posture parameter of the image pickup apparatus 30d.

The description will be made in a case where four image pickup apparatuses 30 in the plurality of image pickup apparatuses 30 change the posture parameter. In a case where four image pickup apparatuses 30a, 30b, 30c, and 30d illustrated in FIG. 15 are the objects to change the posture parameter, there are two combinations such as the combination of the image pickup apparatus 30a and the image pickup apparatus 30b and the combination of the image pickup apparatus 30c and the image pickup apparatus 30d, or two combinations such as the combination of the image pickup apparatus 30a and the image pickup apparatus 30c and the combination of the image pickup apparatus 30b and the image pickup apparatus 30d.

Herein, it is assumed that a first combination of the image pickup apparatus 30a and the image pickup apparatus 30b and a second combination of the image pickup apparatus 30c and the image pickup apparatus 30d are established. In this case, any one in the first combination is set as the first image pickup apparatus, and the other one is set as the second image pickup apparatus. Similarly, also in the second combination, any one of the combination is set as the first image pickup apparatus, and the other one is set as the second image pickup apparatus. The processing apparatus 20 obtains a new posture parameter by changing the posture parameter of the second image pickup apparatus in each of the first combination and the second combination.

The correction system 50 and the correction method according to the embodiment perform the following processes in a case where a positional deviation occurs in at least one of at least two image pickup apparatuses 30 of the excavator 100 which is the work machine for some external factors. In other words, the correction system 50 and the correction method according to the embodiment change the posture parameter of at least two image pickup apparatuses 30 while setting the distance between the first image pickup apparatus and the second image pickup apparatus constant, and obtain a new posture parameter based on the parallax image obtained as a result of searching the corresponding portion between the pair of images obtained by the first image pickup apparatus and the second image pickup apparatus. Herein, at least one of the first image pickup apparatus and the second image pickup apparatus is the image pickup apparatus in which the positional deviation occurs for some external factors.

Through such a process, the correction system 50 and the correction method according to the embodiment can correct the image pickup apparatus 30 which includes the excavator 100 as the work machine. In addition, since there is no need for the correction system 50 and the correction method according to the embodiment to install equipment for the correction, the positional deviation of the image pickup apparatus 30 generated in a user's place of the excavator 100 can be easily and simply corrected. In this way, the correction system 50 and the correction method according to the embodiment can correct the positional deviation of the image pickup apparatus 30 even in a case where there is no equipment for correcting the image pickup apparatus 30, so that there is an advantage that the work is not suspended. The correction system 50 and the correction method according to the embodiment further have an advantage that the positional deviation of the image pickup apparatus 30 can be easily and quickly corrected by a software process without moving the image pickup apparatus 30 where the positional deviation occurs.

The correction system 50 and the correction method according to the embodiment determine the image pickup apparatus 30 of which the posture parameter is necessarily obtained, based on a result obtained by searching the corresponding portion between the pair of images obtained by the pair of image pickup apparatuses 30 in at least two image pickup apparatuses 30 (that is, the ratio of the gray-scaled image occupied in the parallax image). Specifically, the image pickup apparatus 30 in which the normal parallax image is not generated even once is set as the image pickup apparatus 30 of which the posture parameter is necessarily obtained (that is, the image pickup apparatus 30 in which an unallowable positional deviation occurs). Therefore, the correction system 50 and the correction method according to the embodiment can easily and reliably determine the image pickup apparatus 30 of which the posture parameter is necessarily obtained.

Hitherto, the embodiments have been described, the embodiments are not limited to the above-described content. In addition, the above-described components include a range of so-called equivalents such as components which are assumable by a person skilled in the art, and substantially the same components as the assumable components. The above-described components can be appropriately combined. At least one of various omissions, substitutions, and modifications of the components can be made in a scope not departing from the spirit of the embodiments. The work machine is not limited to the excavator 100 as long as the machine is provided with at least the pair of image pickup apparatuses and three-dimensionally measures the object by the stereoscopic method using the pair of image pickup apparatuses, and a work machine such as a wheel loader or a bulldozer may be applied. The process of obtaining the posture parameter may be performed by an external processing apparatus of the excavator 100. In this case, the image picked up by the image pickup apparatus 30 is sent to the external processing apparatus of the excavator 100 through communication for example.

### REFERENCE SIGNS LIST

1 VEHICLE BODY
2 WORK MACHINE
3 REVOLVING SUPERSTRUCTURE
4 CAB
5 TRAVELING BODY
5a, 5b CRAWLER BELT
6 BOOM
7 ARM
8 BUCKET
9 BLADE
10 BOOM CYLINDER
11 ARM CYLINDER
12 BUCKET CYLINDER
13 BOOM PIN
14 ARM PIN
15 BUCKET PIN
20 PROCESSING APPARATUS
21 PROCESSING UNIT
22 STORAGE UNIT
23 INPUT/OUTPUT UNIT
30, 30a, 30b, 30c, 30d, 30L, 30R IMAGE PICKUP APPARATUS
31L, 31R IMAGE PICKUP ELEMENT
32L, 32R, 32Lr IMAGE
33, 33′ PARALLAX IMAGE
50 CORRECTION SYSTEM OF IMAGE PICKUP APPARATUS
100 EXCAVATOR
BL BASE LINE
d PARALLAX
f FOCAL DISTANCE
OCL, OCR, OCc, OCd OPTICAL CENTER
P3 BLADE EDGE
SR GRAY SCALE RATIO
SRc THRESHOLD
TB DETERMINATION TABLE
α, β, γ, θ, φ ANGLE

1. A correction system of an image pickup apparatus comprising:
at least two image pickup apparatuses; and
a processing apparatus that sets a distance between a first image pickup apparatus and a second image pickup apparatus constant in the at least two image pickup apparatuses, changes a parameter defining a posture of the second image pickup apparatus, searches a corresponding portion between a pair of images obtained by the first image pickup apparatus and the second image pickup apparatus, and obtains the parameter based on the searched result.

2. The correction system of the image pickup apparatus according to claim 1,
wherein the parameter defines a rotation of the second image pickup apparatus.

3. The correction system of the image pickup apparatus according to claim 1,
wherein the parameter includes a first parameter that is used to rotate the second image pickup apparatus with the first image pickup apparatus as a center, and a second parameter that is used to rotate the second image pickup apparatus about a center of the second image pickup apparatus.

4. The correction system of the image pickup apparatus according to claim 1,
wherein the processing apparatus determines the first image pickup apparatus and the second image pickup apparatus, of which the parameter is necessarily obtained, based on the result of searching the corresponding portion between the pair of images obtained by a pair of the image pickup apparatuses in the at least two image pickup apparatuses.

5. The correction system of the image pickup apparatus according to claim 4,
wherein the processing apparatus obtains the parameter with respect to a pair of the image pickup apparatuses of which a success rate of a searching is less than a threshold in a case where there are a plurality of the pairs of image pickup apparatuses.

6. A work machine comprising:
the correction system of the image pickup apparatus according to claim 1; and
a plurality of image pickup apparatuses.

7. A correction method of an image pickup apparatus, comprising:
determining whether a parameter of one of a pair of image pickup apparatuses needs to be obtained based on a result of searching a corresponding portion between a pair of images obtained by the pair of image pickup apparatuses in a plurality of image pickup apparatuses;
in a case the parameter is obtained, setting a distance between a first image pickup apparatus and a second image pickup apparatus of the pair of image pickup apparatuses constant, and changing a parameter defining a posture of the second image pickup apparatus so as to search a corresponding portion between a pair of images obtained by the first image pickup apparatus and the second image pickup apparatus; and
obtaining a posture parameter defining a posture of the image pickup apparatus based on a searching result.
